(19) United States
(12) Patent Application Publication
(10) Pub. No.: US 2018/0009255 A1
(43) Pub. Date: Jan. 11, 2018

(54) PHOTOLUMINESCENT WRITING PAD AND NOTEPAD OR NOTEBOOK

(71) Applicant: Kalle KINNUNEN, Hämeenlinna (FI)

(72) Inventor: Kalle KINNUNEN, Hämeenlinna (FI)

(21) Appl. No.: 15/545,792

(22) PCT Filed: Feb. 2, 2016
(86) PCT No.: PCT/FI2016/050066

§ 371 Date: Jul. 24, 2017

(30) Foreign Application Priority Data
Feb. 4, 2015 (FI) 20150037

(51) Int. Cl. B43L 3/00; F21V 33/00; B42D 5/00

(52) U.S. Cl. CPC B43L 3/002; B42D 5/007; F21V 33/0048

(57) ABSTRACT

A photoluminescent writing pad, wherein a) the writing pad is fastened to a back cover of a notebook and arranged to be turned to a writing pad of a page of the notebook, b) the writing pad is arranged to gleam through a writing page thus enabling reading and writing in darkness and c) the writing pad has notches for accommodating a spiral wire, especially spiral or wire or similar binding, of a notebook for securing the writing pad under the page of the notebook to function as an interleaf.

### FIELD OF THE INVENTION

The invention relates to a photoluminescent writing pad, particularly to be used with a notebook or similar. As an example, a notebook consisting of a photoluminescent sheet or sheets, paper sheets or stone paper sheets and covers, such as front cover and back cover, spirally bound together, and into at least one of which a photoluminescent writing pad is attachable and is made of e.g. plastic-based or aluminium-based material or a photoluminescent self-adhesive sheet on plastic or some other material.

### BACKGROUND OF THE INVENTION

Especially from publication CN201998596 (U) is known a card book, which includes a protective pouch sealed from three surfaces, pages of the book and a photoluminescent plate. The card book is meant to be used for reading individual card pages and possibly for making notes. The solution does not offer a significant improvement especially in a purpose of making notes, because it's difficult to make notes to individual cards or sheets when the card is in the protective pouch.

Writing pads are also known from U.S. Pat. Nos. 3,978,340 and 5,381,310 and from US patent application 2013/0315651 and from GB patent 559,603.

### BRIEF DESCRIPTION OF THE INVENTION

An object of the present invention, a photoluminescent writing pad, is to provide an improvement, especially to the above mentioned problems. It is characterizing for the writing pad according to the invention for implementing this object that is has features according to the characterizing part of claim 1. An advantage of the writing pad is especially emphasized when it is used in a notebook under a single writing sheet to emit light which allows writing in darkness. In addition, e.g. when used by the authorities, the writing pad prevents writing from creating a depression to underlying pages thus increasing security of information. It also makes e.g. a notebook more rigid and writing is easier.

In an advantageous embodiment lines or check pattern, image, photo, logo and/or text is printed to a part or whole area of the photoluminescent writing pad with silk printing or other suitable technology so that desired parts of any figures of the writing pad placed under a writing sheet can be seen.

The writing pad according to the invention offers a clear improvement especially in demanding conditions as it allows e.g. working in full darkness. The writing pad according to the invention is suitable for example conscripts, woodsmen, police, fire fighters, professional drivers and geocachers.

An advantageous embodiment is also that various clear or translucent writing materials, such as paper or plastic or similar can be used with the writing pad. Especially materials suitable for prevailing needs can be used, such as ordinary paper or water-resistant stone paper.

An advantageous embodiment is that the photoluminescent writing pad can be charged for example in car headlight or by using a flashlight. In a very advantageous embodiment green light of the photoluminescent writing pad does not blind night-vision devices or distract visibility.

Embodiments of the writing pad according to the invention are defined in the dependent claims.

### BRIEF DESCRIPTION OF THE DRAWINGS

In the following the invention will be described in greater detail with reference to the accompanying drawings, in which

FIG. 1 illustrates a side-view to an advantageous embodiment for fastening a photoluminescent writing pad (1) to a spiral bound pocket notepad;

FIG. 2 illustrates the photoluminescent writing pad (1) of FIG. 1 when it's fastened to a back cover using a sticker (5), and having notches for securing (4) it to a spiral wire;

FIG. 3 illustrates the securing of the photoluminescent writing pad (1) of FIG. 1 to the spiral wire when it is also fastened to the back cover with a sticker (5);

FIG. 4 illustrates releasing of the photoluminescent writing pad (1) of FIG. 1 from spiral by raising it, notches for securing (4) for placing it under writing sheet;

FIG. 5 illustrates the photoluminescent writing pad (1) of FIG. 1 placed under a writing page (3);

FIG. 6 illustrates light reflected by the photoluminescent writing pad (1) of FIG. 1 and reflection below the writing page (3) when the writing pad is placed below the writing page;

FIG. 7 illustrates use of the photoluminescent writing pad (1) of FIG. 1 on top of a spiral bound notepad for receiving light and is ready for use as soon as possible after moving to darkness; and

FIG. 8 illustrates storing of the photoluminescent writing pad (1) of FIG. 1 inside a spiral bound notepad.

### DETAILED DESCRIPTION OF THE INVENTION

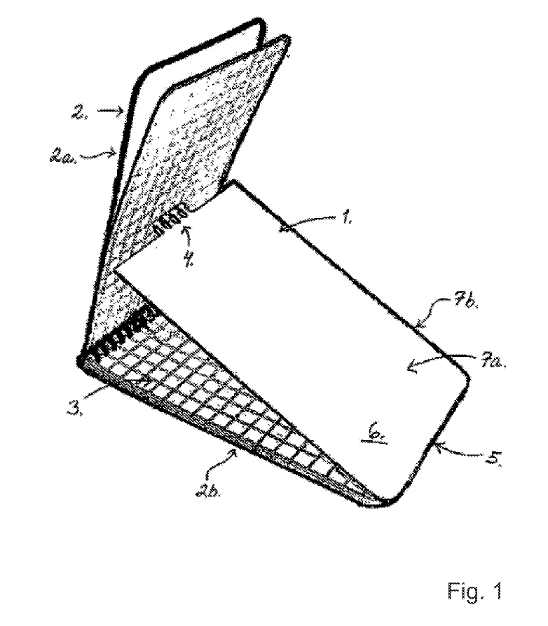

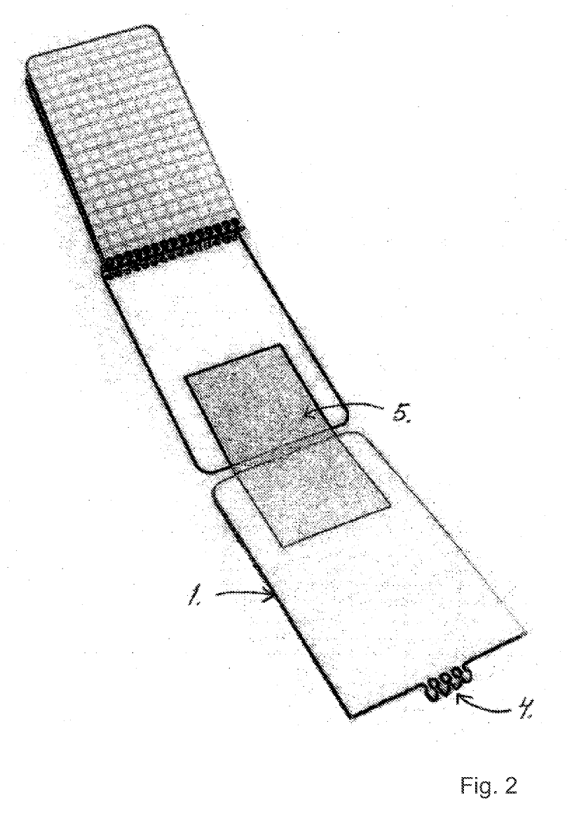

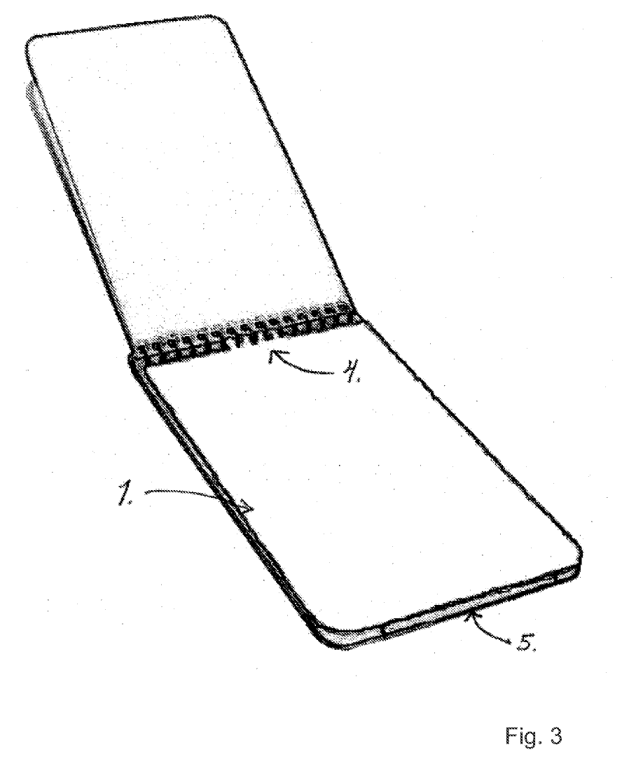

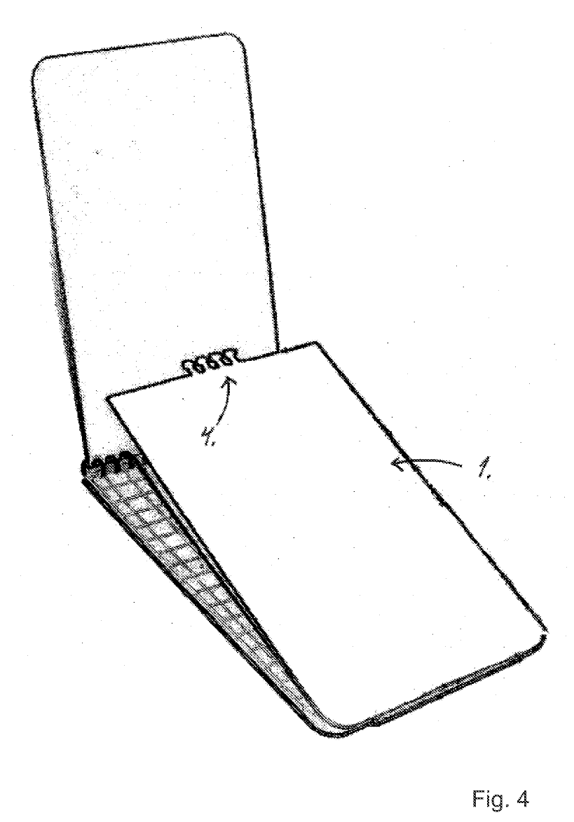

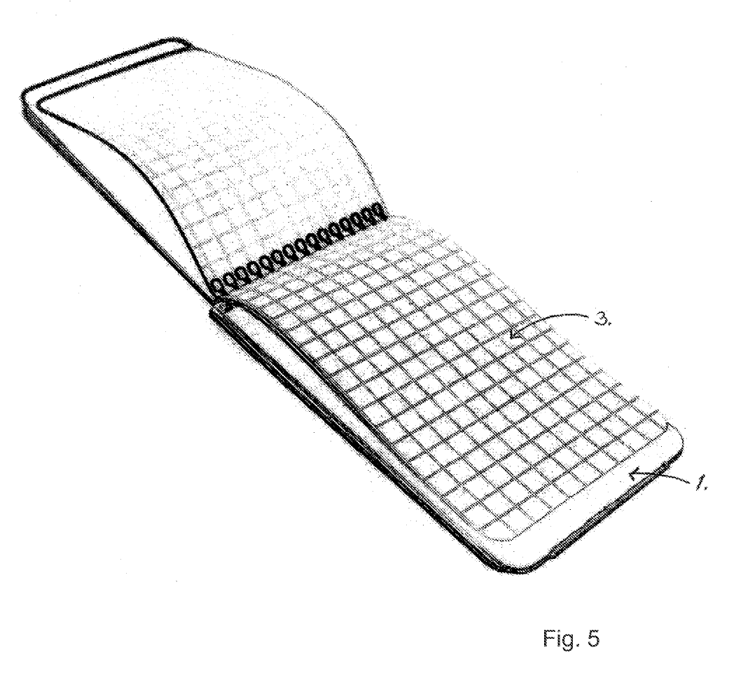

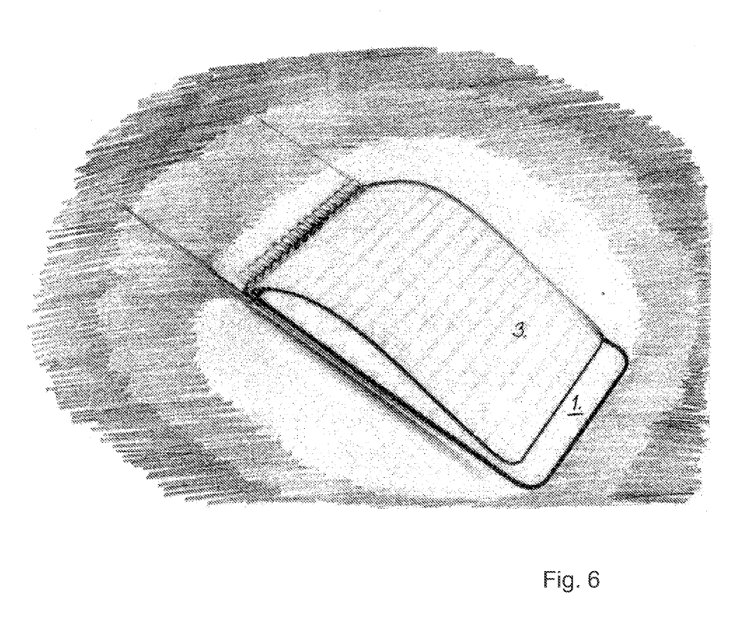

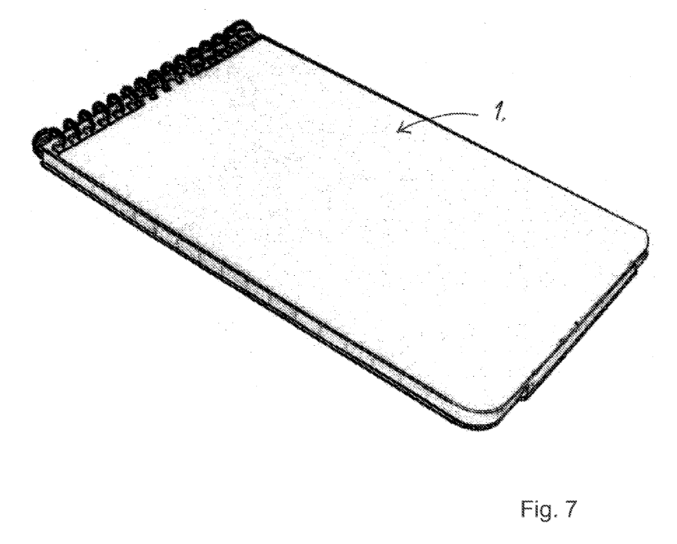

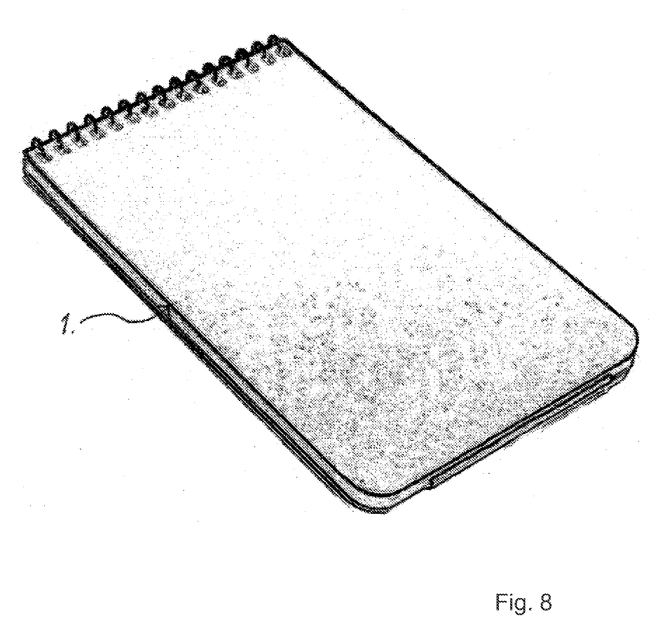

An advantageous embodiment especially for demanding conditions is a water-resistant writing pad with water-resistant covers and stone paper sheets which have been put together using e.g. spiral binding technique according to FIGS. 1 to 8. In a very advantageous embodiment the photoluminescent writing pad can be introduced under each separate page/sheet and secured to the spiral wire. The writing pad can also be fastened from various directions, for example upper edge, sides, lower edge or the writing pad can be unfastened. The writing pad can also be used as an interleaf.

In a very advantageous embodiment the writing pad enables reading and writing of necessary information of any given time. In an advantageous embodiment of the photoluminescent writing pad according to the invention a spiral bound notepad is put together from one of the edges using e.g. spiral binding technique according to FIGS. 1 to 8, the writing pad is fastened to a back cover with a sticker 5 and it has notches 4 for securing it to the spiral wire.

Furthermore, an advantageous embodiment is use of the writing pad in a spiral bound notepad or notebook, wherein note sheets are water-resistant stone paper or similar water-resistant material.

Furthermore, an advantageous embodiment is suitability of the writing pad to demanding conditions. An embodiment is a photoluminescent writing pad 1 that is fastened to a back cover of a notebook or a spiral bound notepad and arranged to be turned to a writing pad of a page of the notebook or spiral bound notepad. The writing pad 1 is arranged to gleam through a writing page thus enabling reading and writing in darkness. The writing pad 1 comprises notches 4 for accommodating a spiral wire, especially spiral or wire or similar binding, of a notebook or notepad for securing the writing pad 1 also from another end under the page of the notebook or spiral bound notepad to function as an interleaf.

In an embodiment the writing pad 1 comprises printed lines or check pattern covering a part or all of the writing pad.

In an embodiment note sheets of the photoluminescent writing pad are stone paper or similar water-resistant material. Note sheets can be pages that can be written onto.

It will be obvious to a person skilled in the art that embodiments are not limited to the examples described above but may vary within the scope of the claims. In this context material of the photoluminescent writing pad can be instead of e.g. coated plastic sheet other suitable materials, e.g. aluminium-based material. In this context also the notches for securing the writing pad can be altered if necessary.

1-5. (canceled)

6. A photoluminescent writing pad, wherein
the writing pad is fastened from one end to a back cover of a notebook or a notepad and arranged to be turned to a writing pad of a page of the notebook or the notepad;
the writing pad is arranged to gleam through a writing page thus enabling reading and writing in darkness; and
the writing pad comprises notches for accommodating a spiral wire, or a similar binding, of the notebook or the notepad for securing the writing pad also from another end under the page of the notebook or the notepad to function as an interleaf.

7. The photoluminescent writing pad of claim 6, wherein the writing pad is fastened to the back cover of the notebook or the notepad and arranged to be turned under any page of the notebook or the notepad thus enabling reading and writing for each page.

8. The photoluminescent writing pad of claim 6, wherein the writing pad comprises printed lines or a check pattern covering a part of the writing pad or the whole writing pad.

9. A spiral bound notepad or a notebook comprising note sheets and the photoluminescent writing pad of claim 6, wherein the note sheets of the notepad or the notebook are stone paper or similar water-resistant material.

10. The photoluminescent writing pad of claim 7, wherein the writing pad comprises printed lines or a check pattern covering a part of the writing pad or the whole writing pad.

11. The photoluminescent writing pad of claim 6, wherein the notebook or the notepad is spiral bound.

12. A writing pad, wherein
the writing pad is configured to be fastened from one end thereof to a back cover of a notebook or a notepad and to be turned to a writing pad under a single writing page of the notebook or the notepad;
the writing pad is photoluminescent and configured to emit light through said single writing page so as to enable reading thereof and writing thereon in darkness; and
the writing pad comprises notches for accommodating a binding of the notebook or the notepad for securing the writing pad also from another end thereof under the single writing page of the notebook or the notepad.

13. The photoluminescent writing pad of claim 12, wherein the binding comprises a spiral wire.
